(19) United States
(12) Patent Application Publication
(10) Pub. No.: US 2018/0237024 A1
(43) Pub. Date: Aug. 23, 2018

(54) REMOTE MANAGEMENT OF VEHICLE INTERNAL ENVIRONMENT

(71) Applicant: Microsoft Technology Licensing, LLC, Redmond, WA (US)

(72) Inventors: Lakshmi Narayana Mummidi, Bellevue, WA (US); Parmjeet Singh, Bellevue, WA (US)

(21) Appl. No.: 15/436,649

(22) Filed: Feb. 17, 2017

(51) Int. Cl. B60W 40/08; G06N 5/04; G06N 99/00; G07C 5/00

(52) U.S. Cl. CPC B60W 40/08; G06N 5/04; B60W 2710/30; G07C 5/008; G06N 99/005

(57) ABSTRACT

Techniques for determining conditions associated with a vehicle are described. Vehicle data associated with one or more conditions of a vehicle, passenger data indicative of one or more occupants of the vehicle, and user data indicative of a state of a computing device associated with a user are received. The received environment data, passenger data, and user data are analyzed. Based on the analyzing, a state of the vehicle, occupants, and user is derived. An action is determined based on the derived state, the received vehicle data, passenger data, and user data, and one or more user preferences. An action is initiated via a communication to the vehicle, a communication to the computing device associated with the user, a communication to a predetermined contact, or a combination.

### BACKGROUND INFORMATION

The internal environment of a vehicle may change over time, depending on factors such as location, time of day, and weather conditions. If a person or pet is left in the vehicle, a sudden or rapid change in the internal environment of the vehicle may subject the person or pet to a hazardous condition.

### SUMMARY

Methods and systems for determining conditions associated with a vehicle are described. Vehicle data associated with one or more conditions of a vehicle, passenger data indicative of one or more occupants of the vehicle, and user data indicative of a state of a computing device associated with a user are received. The received environment data, passenger data, and user data are analyzed. Based on the analysis, a state of the vehicle, occupants, and user is derived. An action is determined based on the derived state, the received vehicle data, passenger data, and user data, and one or more user preferences. An action is initiated via a communication to the vehicle, a communication to the computing device associated with the user, a communication to a predetermined contact, or a combination.

The features, functions, and advantages can be achieved independently in various embodiments or may be combined in yet other embodiments, further details of which can be seen with reference to the following description and illustrations.

### BRIEF DESCRIPTION OF THE DRAWINGS

FIG. 1 is a system diagram of an example computer environment, in accordance with an embodiment.

FIG. 2 is a block diagram of an example vehicle management system, in accordance with an embodiment.

FIG. 3 is a state diagram showing modes of operation of an example computing system and example transitions between modes of operation, in accordance with an embodiment.

FIG. 4 is an illustration of system that may be used in various embodiments.

FIG. 5 is a flow diagram showing an example set of operations for determining conditions associated with a vehicle.

### DETAILED DESCRIPTION OF EMBODIMENTS

This disclosure describes techniques and systems for the remote monitoring and management of the internal environment of a vehicle in conjunction with a remote device such as a smartphone or tablet. The described embodiments may be suitable for situations such as when children or pets are left inside a vehicle while a user leaves the vehicle and/or the area.

When children or pets are left inside a vehicle, situations may arise which can pose problems to the children or pets. The parent or owner may be unaware of changes to the environment in the vehicle, such as the rate at which the internal temperature is increasing, the drop in oxygen levels, and other changes inside the vehicle. Furthermore, the parent or owner may lose track of time and not to return to the vehicle in a timely manner or otherwise check up on the vehicle.

In some embodiments of the present disclosure, a combination of communications with a user device and a predetermined set of automated actions may be used to address the issues noted above. In one embodiment, a mobile device and one or more systems in the vehicle may be communicatively coupled using communications technologies such as cellular, Bluetooth, and WiFi. When the owner or parent exits the vehicle, the exit event may be detected and logged, initiating a process to monitor the vehicle, the conditions inside the vehicle, and the status of persons or animals in the vehicle. The exit event may be detected using a combination of factors, such as monitoring the status of various systems and parts of the vehicle such as the vehicle location, vehicle speed, seat belt status, door status, weight on the driver's seat, and state of the communication link between the on-board system and the user device.

A communication may be provided to the mobile device to provide status of conditions inside the vehicle. Furthermore, an on-board system may provide additional notifications to the user device. The user device may execute an on-board monitoring application. The on-board monitoring application may be configured to prompt the user of options that may be selected via a user interface rendered on the user device.

In one embodiment, a notification may be provided to the user's device which not only reminds the owner or parent of the vehicle's status with regard to pets and/or children or other occupants in the vehicle, but provides the owner or parent with various selectable options.

For example, the owner or parent may select an option to indicate that the owner or parent does not want any children or pets to be left inside the car. In an embodiment, the selection of this option may result in a notification being provided to the owner or parent if it is detected that the owner or parent has exited and left the vehicle and a child or pet is detected in the vehicle.

In another example, the owner or parent may select an option to indicate that the owner or parent will leave kids or pets inside the car, and that the owner or parent wishes to be reminded periodically that kids or pets are in the vehicle. The owner or parent may also select an option to be notified about any changes in car's internal environment. In one embodiment, the owner or parent may be provided an option to communicate, for example using video and/or video, to the kids or pets in the vehicle.

In some embodiments, the owner or parent may select an option to automatically control features of the vehicle and control the vehicle's internal environment in response to changes in car's internal environment, time of day, user selected options, and other factors. For example, on-board systems may be invoked to automatically roll down one or more windows or open a sunroof, turn on and modify air conditioning levels, or automatically start the engine in the park mode. The owner or parent may be notified of the actions taken, and the owner or parent may be provided options to reverse or otherwise modify the actions taken.

Based on the option selected by the owner or parent, a vehicle management system, as further described herein, may establish communications with on-board vehicle systems and synchronize commands between the mobile device and the on-board vehicle systems as needed to effectuate the options selected by the owner or parent.

In some embodiments, active operations for remote monitoring and management of the internal or other environments of a vehicle in conjunction with a computing device such as a smartphone or tablet may be limited to time periods and/or locations based on a profile configured by the user or parent. For example, operations may be limited or disabled during night hours, or when the vehicle is at an identified location, such as at home or at the office.

In some embodiments, active operations for remote monitoring and management of the internal environment of a vehicle in conjunction with a computing device may include determining a state of the computing device. The state may, in some examples, refer to a change in the computing device's state of motion associated with a change in the computing device's location over time. The state may be determined by monitoring existing signals of the computing device, and/or location data generated by applications on the computing device. Such existing signals and location data may include signals that indirectly or directly suggest a state of the computing device. For example, a signal indicative of the computing device being connected to a charging station while not directly indicative of a state of the computing device does indirectly suggest that the computing device may be stationary. Such indirect passive signals may be used as a low probability suggestion of the current state. The accuracy of the determined state has an associated uncertainty, so the determined state may have a score (or metric). The score quantifies a likelihood of the determined state coincides with an actual state of the computing device.

The determination of state is one example of how operations for remote monitoring and management of the internal environment of a vehicle may be implemented using an inferred or deduced set of conditions and a set of rules for determining and triggering responsive actions. In one embodiment, a set of conditions may be used to determine that an action should be triggered. In response, the set of conditions as well as other information may be collected and analyzed to determine the specific action to be effected. One or more rules can be used to make either or both determinations. One example of a condition which can trigger an action can be a failure of the parent or owner to acknowledge a notification that is provided to the computing device of the parent or owner. The vehicle management system may initially send a notification to the computing device of the parent or owner when it is determined that the parent or owner has departed the vehicle. The notification may include an option to acknowledge the notification. The vehicle management system may initiate a timeout period during which the owner or parent may respond to the notification. If an acknowledgement is not received during the notification period, then the vehicle management system may determine one or more actions as part of a fallback logic for responding to the situation defined by the associated set of conditions.

Additionally, in some cases the parent or owner may not be able to promptly acknowledge the notification and initiate an appropriate course of action. In such cases it may be desirable for the vehicle management system to determine and execute one or more actions based on an inferred or deduced set of conditions and a set of rules for determining and triggering the actions. This may be particularly useful in situations where the owner or parent does not know what to do and may select options that may not be the best course of action based on the conditions and circumstances.

Examples of a fallback position if the primary contact (e.g., parent or owner) is not responding may include actions such as dialing an emergency contact or dialing 911. The emergency contact may be set by the user as part of a set of user preferences. Default conditions may be established, for example dialing 911 or an emergency monitoring service. In some embodiments, the vehicle management assistant may have a prioritized list of people to call.

In some embodiments, actions may be determined based on the location of the vehicle. For example, the geographic location of a vehicle may establish that the vehicle is in a location that is determined to be at a warm or hot temperature at that time of day. The geographic location may be determined based on location determination techniques such as the GPS position or based on triangulation techniques.

In some embodiments, the actions may be determined based on the sensed temperature inside the vehicle. For example, a vehicle temperature sensor may provide temperature information that may be accessible via on on-board network.

In some embodiments, the actions may be determined based on the number of persons in the vehicle. Furthermore, actions may be determined based on the size of the person. For example, a smaller person such as a child may be more severely impacted by changes in temperature inside the vehicle. The presence of a person or animal and the number of occupants may be determined from on-board sensors such as weight sensors, motions sensors, or heat detectors.

In some embodiments, the actions may include sending one or more notifications to the mobile device of the parent or owner. The notifications can be sent periodically or at a schedule determined by user preferences selected by the parent or owner. The notifications may include information identifying that there is an unsafe condition in the vehicle, the number of detected occupants in the vehicle, and other information as available or as selected by the user.

In some embodiments, the actions may include initiating one or more functions in the vehicle. For example, various optional controllable features may be activated, such as opening one or more windows or roof of the vehicle, starting the engine in a safe or parked mode, activating the climate control system, activating a communication system such as a video and/or audio communication system, and the like.

In some embodiments, the actions may comprise fall back measures that may be useful in particular when the owner or parent does not respond or is not able to respond, for example if the owner or parent is out of range or otherwise not able to receive notifications, if the parent or owner is unable to make a decision, or if the owner or user incorrectly selects an option that may result in a more dangerous situation for the vehicle occupants. For example the owner or parent may be overwhelmed by a sudden notification or by a large amount of information and become temporarily unable to respond promptly.

In some embodiments, the actions may be determined based on the presence and location of the owner or parent. The status of the owner or parent may be inferred using information such as the Bluetooth connection for the owner or parent becoming disconnected, suggesting that the owner or parent has left the vehicle and is of a sufficient distance so as to disconnect from the Bluetooth transceiver in the vehicle system. As another example, if the key is in the car ignition, then it may be inferred that the driver has not left the vehicle and is in the vicinity of the vehicle. However, if the owner or parent has left the vehicle and the key is in the ignition, it may be inferred that the owner or parent has left the vehicle with the key in the ignition based on other factors such as the loss of a Bluetooth connection with the owner or parent's mobile device coupled with the doors being lock and GPS information indicating that the mobile device of the owner or parent is not in the same vicinity of the vehicle.

In some embodiments, the actions may be determined based on the location of the vehicle. If the vehicle is at home, it may be inferred that the potential for accidentally leaving a child or pet in the vehicle is low. The probability of unintentionally leaving a pet or child in the car may be adjusted in this way.

The vehicle management system may provide intelligent assistance to the owner or parent by providing notifications, making autonomous determinations based on available information, and initiating actions to mitigate potentially harmful situations. The vehicle management system may be configured to operate with or without inputs from the parent or owner, thus allowing for actions to be initiated without the single point of failure of the parent or owner failing to respond. The vehicle management system thus provides a fallback logic that can proactively and autonomously take actions based on available information.

In some embodiments, the vehicle management system may be configured to adapt to the specific characteristics of the user. For example, the vehicle management system may modify actions based on whether the user is advanced in age or has physical disabilities. The vehicle management assistant may thus determine that the user may not be able to respond promptly to notifications based on such conditions.

In some embodiments, the vehicle management system may be configured to modify responses based on feedback from the user using aspects of machine learning, thus allowing for the determinations and actions to be improved over time

In some embodiments, the vehicle management system may be executed as a function on a mobile device as well as a computing device associated with the vehicle. The computing device can be integrated with the vehicle systems and configured to obtain data that indicates the status of various vehicle subsystems and components. Various functions of the vehicle management system may be distributed between applications running on the computing device of the vehicle and the mobile device of the user. Additionally, some functionality may execute as a cloud-based service.

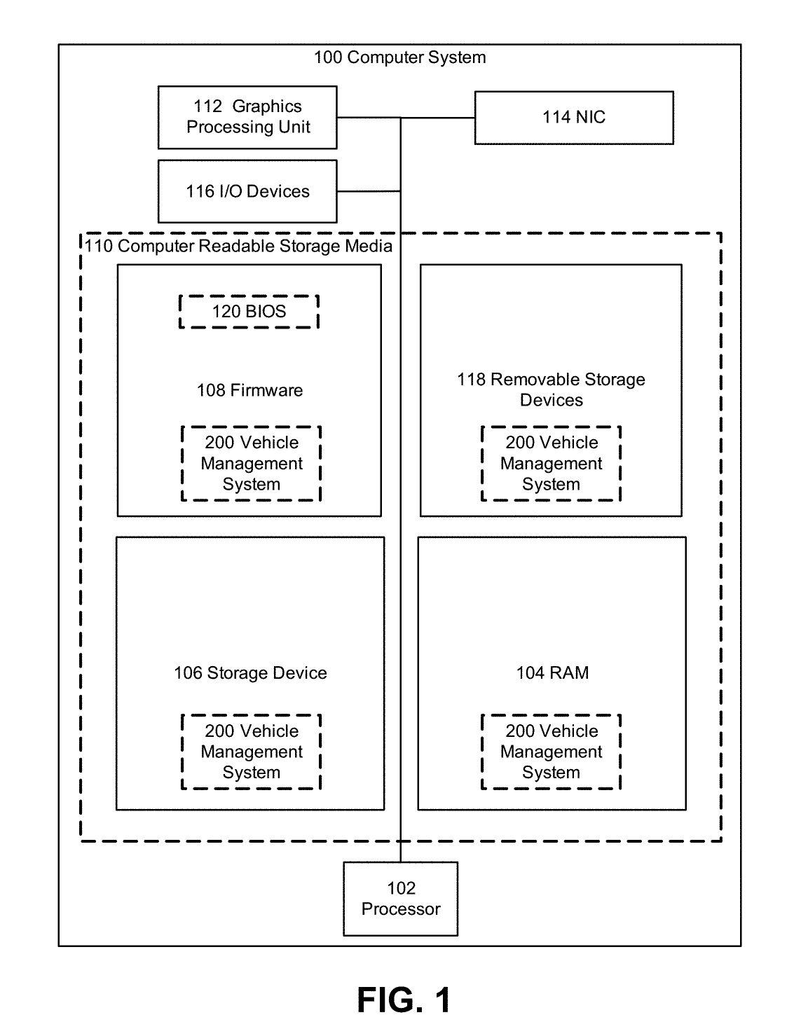

Referring to FIG. 1, an example computing environment in which embodiments of the present disclosure may be implemented is depicted and generally referenced as computing environment 100. As utilized herein, the phrase “computing environment” generally refers to a computing device with processing power and storage memory, which supports operating software that underlies the execution of software, applications, and computer programs thereon.

As shown by FIG. 1, computing environment 100 includes processor 110 (e.g., an execution core) that is interconnected by one or more system buses that couple various system components to processor 110. While one processor 110 is shown in the example depicted by FIG. 1, one skilled in the art will recognize that computing environment 100 may have multiple processors (e.g., multiple execution cores per processor substrate and/or multiple processor substrates each having multiple execution cores) that each receive computer-readable instructions and process them accordingly. The one or more system buses may be any of several types of bus structures including a memory bus or memory controller, a peripheral bus, and a local bus using any of a variety of bus architectures. In an embodiment, computing environment 100 also includes a host adapter, Small Computer System Interface (SCSI) bus, and an external storage device connected to the SCSI bus.

Computing environment 100 also typically includes or has access to various computer-readable media. Computer-readable media is any available media accessible to computing environment 100 that embodies computer-readable, processor-executable instructions. By way of example, and not limitation, computer-readable media includes computer-readable storage media 110 and communication media. Aspects of the present disclosure are implemented by way of computer-readable, processor-executable instructions that are stored on or transmitted across some form of computer-readable media.

Communication media typically embodies computer-readable instructions, data structures, program modules or other data in a modulated data signal such as a carrier wave or other transport mechanism and includes any information delivery media. “Modulated data signal”, as used herein, refers to a signal having one or more characteristics that each may be configured or modified to encode data into the signal for propagation through a communication channel. Examples of such communication channels include wired media such as a wired network or direct-wired connection, and wireless media such as acoustic, RF, infrared and other wireless media.

Computer-readable storage media 110 can include, for example, random access memory (“RAM”) 104; storage device 106 (e.g., electromechanical hard drive, solid state hard drive, etc.); firmware 108 (e.g., FLASH RAM or ROM); and removable storage devices 118 (e.g. CD-ROMs, floppy disks, DVDs, FLASH drives, external storage devices, etc). It should be appreciated by those skilled in the art that other types of computer-readable storage media can be used such as magnetic cassettes, flash memory cards, and/or digital video disks. Generally, such computer-readable storage media can be used in some embodiments to store processor executable instructions tangibly embodying aspects of the present disclosure. Consequently, computer-readable storage media explicitly excludes signals per se.

Computer-readable storage media 110 can provide non-volatile and/or volatile storage of computer-readable, processor-executable instructions, data structures, program modules and other data for computing environment 100. A basic input/output system (“BIOS”) 120, containing the basic routines that help to transfer information between elements within computing environment 100, such as during start up, can be stored in firmware 108. A number of programs may be stored on firmware 108, storage device 106, RAM 104, and/or removable storage devices 118. These programs can include an operating system and/or application programs. In a specific embodiment, computer-readable storage media 110 of a computing environment 100 can store visit detection system 200, which is described in more detail in the following paragraphs. In this example embodiment, visit detection system 200 can be executed by processor 110 thereby transforming computing environment 100 into a computer environment configured for a specific purpose, i.e., a computer environment configured according to techniques described in this disclosure.

With continued reference to FIG. 1, commands and information may be received by computing environment 100 through input/output devices (“I/O devices”) 116. I/O devices 116 include one or more input devices, output devices, or a combination thereof. Examples of input devices include a keyboard, a pointing device, a touchpad, a touchscreen, a scanner, a microphone, a joystick, and the like. Examples of output devices include a display device, an audio device (e.g. speakers), a printer, and the like. These and other I/O devices are often connected to processor 110 through a serial port interface that is coupled to the system bus, but may be connected by other interfaces, such as a parallel port, game port, or universal serial bus (USB). A display device can also be connected to the system bus via an interface, such as a video adapter which can be part of, or connected to, a graphics processor unit.

Computing environment 100 may operate in a networked environment and receive commands and information from one or more remote computers via logical connections to the one or more remote computers, such as a remote computer. The remote computer may be another computer, a server, a router, a network PC, a peer device or other common network node, and typically can include many or all of the elements described above relative to computing environment 100.

When used in a LAN or WAN networking environment, computing environment 100 can be connected to the LAN or WAN through network interface card (“NIC”) 114. NIC 114, which may be internal or external, can be connected to the system bus. In a networked environment, program modules depicted relative to computing environment 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

In a networked environment, program modules depicted relative to computing environment 100, or portions thereof, may be stored in a remote memory storage device accessible via NIC 114. It will be appreciated that the network connections shown are exemplary and other means of establishing a communications link between the computers may be used. In an embodiment where computing environment 100 is configured to operate in a networked environment, the operating system is stored remotely on a network, and computing environment 100 may netboot this remotely-stored operating system rather than booting from a locally-stored operating system. In an embodiment, computing environment 100 comprises a thin client having an operating system that is less than a full operating system, but rather a kernel that is configured to handle networking and display output.

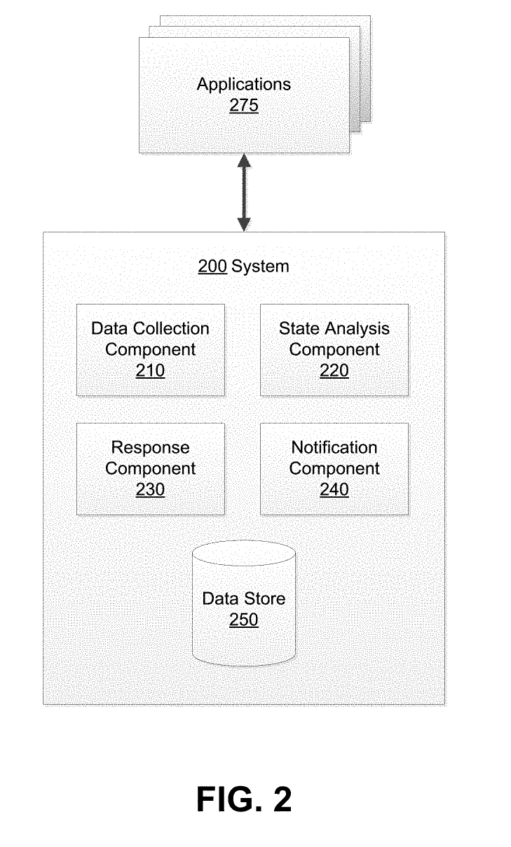

Turning now to FIG. 2 is a block diagram illustrating an example vehicle management system 200 suitable for implementing vehicle status determinations and actions, in accordance with one or more embodiments. In an embodiment, system 200 may be implemented as a single computing device, such as computing environment 100 of FIG. 1. System 200 may take on any of a variety of forms. By way of example, system 100 may be a mobile telephone, smart phone, laptop computing device, desktop computing device, server, tablet computer, personal digital assistant (PDA), a wearable computer, a gaming device, or any other computing device.

In an embodiment, system 200 may be implemented by multiple computing devices, such as computing environment 100 of FIG. 1 and at least one server component or a computing component located in a vehicle and accessed via a network connection (e.g., a cellular network, a WiFi/broadband network, a local area network, and the like). The at least one server component may comprise a single computing device or multiple computing devices cooperating in a distributed environment. For example, the at least one server component may be provided via multiple computing devices arranged in a distributed environment that collectively provide one or more of the functionalities described herein.

As shown by FIG. 2, system 200 includes such components as data collection component 210, state analysis component 220, response component 230, notifications component 240, and data store 250. Data collection component 210 may be generally responsible for receiving (acquiring, obtaining, or accessing) passive and active signals from one or more sources. In an embodiment, the passive and active signals may be received by data collection component 210 and stored in one or more data stores, such as data store 250. The one or more data stores may thus be available to state analysis component 220, response component 230, and notification component 240.

Passive and active signals may be received from a variety of sources. By way of example, passive signals may include device state data, network connection data, application activity data, inertial data (e.g., accelerometer, gyroscopes, and magnetic field sensors), and the like. In an embodiment, any type of existing signal is usable as a passive signal as long as it increases or decreases a likelihood of determining state for a vehicle and its inhabitants. Device state data may include information indication of a connection to an alternating current (“AC”) source or a docking station, an airplane mode setting of the computing device being in an “OFF” position, user interaction with or proximity to the computing device, time zone updates (e.g., a change in a cellular network identity and time zone), receiving tracking status events from a hardware (“HW”) offloaded (low power) tracking engine, and the like.

Network connection data may include information, such as whether the computing device is paired with a vehicle's Bluetooth system, wired Ethernet connections, wireless access point connections, variations in a number of visible wireless access points (e.g., Wifi basic service set identifiers), signal strength measurements (e.g., received signal strength indicator values) associated with visible wireless access points, and the like. Application activity data may include information, such as whether a user is capturing image data with a camera of the computing device, credit card or other payment transactions completed with the computing device (e.g., an near field communication “NFC” tap), completion of a navigation session associated with a mapping application, receiving geo-fence events for geo-fences set by other applications (e.g., applications 275), and the like.

Passive signals may also include derived data. As another example of a raw system signal that can be used as a passive signal includes: “user is active on the device”. Examples of derived signals include: “user active, to take a picture”; “user active, to turn airplane mode OFF”; and the like. In an embodiment, some derived signals may be a stronger indication that a computing device is in a stay state (the user is remaining in the vehicle) than raw signals. As used herein, “derived data” refers to data indicative of a state of a computing device that is derived from other passive signals. For example, derived data may include velocity data associated with the computing device that is derived from GPS positions opportunistically obtained from unrelated applications (e.g., applications 275), system activity, and the like. As another example, derivative data may include inertial data derived based on recent location determinations.

By way of example, active signals may include data that is actively solicited, requested, or generated specifically for system 200. In an embodiment, a notification may be generated on the user device's user interface, and the user may enter information that is provided to system 200. Such user entered information may be considered active signals.

State analysis component 220 may be configured to determine scores (or metrics) for vehicle states based on the passive and active signals as well as other information. For example, state analysis component 220 may use as input statistical information associated with the passive and active signals. Furthermore, state analysis component 220 may determine scores determined for possible vehicle states. The score may indicate a likelihood that an actual state of a vehicle or its inhabitants actually corresponds to the determined state.

In an embodiment, a score may be expressed as percentages, discrete enumerations (e.g., low, high, or unknown), or a combination thereof. Examples of statistical information may include any combination of confidence scores, variance metrics, central tendency values, probability distribution functions, and the like. In determining a score for a vehicle state, state analysis component 220 may receive one or more passive or active signals as input and provide the score for a determined state as output. The passive or active signals may be received at any level of granularity including: continuously, periodically (e.g., every second, every minute, every ten minutes, etc.), or upon transitioning logic states (e.g., on to off, high to low, etc.).

Subject to design complexity and efficiency constraints, state analysis component 220 may utilize various functions to determine scores for states based on passive or active signals. In an embodiment, a score may be determined by taking a weighted average of individual passive or active signals. In an embodiment, a score may be determined in part using actively obtained signals indicative of a vehicle state. In an embodiment, weights may be determined using training data obtained from data sets composed of previously-received passive or active signals. For example, a computing device may run in a test mode in which passive or active signals are collected along with GPS receiver signals providing verified stay and move states associated with the passive or active signals. That is, location data may be obtained every N minutes to obtain a ground truth that could be correlated with the passive or active signals to generate training data. In an embodiment, a score may be determined using a custom code implemented in a programming language of choice that defines relationships between individual passive or active signals and an actual state of the computing device.

In an embodiment, any known artificial intelligence, machine learning, knowledge-based, or rule-based mechanisms to train machine learned models that receive passive or active signals as input and provide a score for a state as an output. Examples of such mechanisms include support vector machines, neural networks, expert systems, Bayesian belief networks, fuzzy logic, data fusion engines, classifiers, and the like. In training the machine learned models (e.g. find optimal values of for model parameters), objective functions may be used to measure the performance of the models using a subset of the training data as a function of the model parameters. For example, optimal values of the parameters of a model may be determined by finding a minimum of the objective function.

As another example, multiple iterations of a stochastic gradient descent procedure may be performed to find the optimal values of the parameters. In an embodiment, the machine learning model is composed of a single level of linear or non-linear operations. In an embodiment, the machine learning model is a deep network composed of multiple levels of non-linear operations. For example, the machine learning model may be a neural network with one or more hidden layers.

As an example, state analysis component 220 may determine a score for a state using a logistic function. One skilled in the art will recognize that one property of logistic functions is that for any value of an input (i.e., independent variable) an output value is always within a range of [0,1], which makes logistic functions suitable for probabilistic applications. In this example, state analysis component 220 provides three (Boolean) passive signals as input to a logistic function. The three passive signals of this example are: (i) whether the ignition is off (“off”); (ii) whether the vehicle door is locked (“locked”); and (iii) whether the user's computing device is paired with the vehicle's Bluetooth system (“carkit”). One skilled in the art will recognize that state analysis component 220 may provide a score based on dozen or even hundreds of passive or active signals. In an embodiment, passive or active signals may be categorized as categorical or continuous.

State analysis component 220 in this example may provide the three passive signals into the following “user has left vehicle” state equation to determine a score for the “user has left vehicle” state:

$${P}_{left} ( off , locked , carkit ) = \frac{1}{1 + {e}^{- ( 0.5 * off + locked + 1.2 * carkit )}} \qquad Equation 1$$

The “user has left vehicle” state equation of this example demonstrates several things. First, in the absence of all three passive signals (i.e., off=0, locked=0, carkit=0), a score for the “user has left vehicle” state is 0.5. In this example, this 0.5 score for the stay state may be used as an “indeterminate” threshold that indicates there is insufficient information available to determine that the vehicle is in a “user has left vehicle” state.

Second, the “user has left vehicle” state equation of this example also demonstrates that some passive signals may increase the likelihood that the vehicle is in a given state (i.e., a positive correlation exists), while other passive signals may decrease the likelihood that the computing device is in a given vehicle state (i.e., a negative correlation exists). Here, the “off” and “locked” passive signals increase the likelihood that the computing device is in a “user has left vehicle” state. In contrast, another passive signal may decrease the likelihood that the vehicle is in the “user has left vehicle” state because the vehicle is potentially moving.

Third, individual passive signals may be weighted to reflect a passive signal's influence on the score relative to the other passive signals. Here, the “off” passive signal with a weight of 0.5 is a weaker indicator of the stay state than the “locked” passive signal with a weight of 1. Also, the “carkit” passive kinematic signal with a weight of 1.2 is a stronger indication that the vehicle is in a “user has left vehicle” state than the “locked” passive signal with a weight of +1 is that the vehicle is in a stay state.

State analysis component 220 in this example would also provide the three passive signals into a “user remains in vehicle” state equation to determine a score for the “user remains in vehicle” state. For example, the “user remains in vehicle” state equation may be as simple as:

Pᵣₑₘₐᵢₙ(off, locked, carkit)=(1−P_{stay}) Equation 2:

In some instances as in this example, the “user has left vehicle” state equation and the “user remains in vehicle” state equation may both return a low score, which indicates that the scores for the “user has left vehicle” state and “user remains in vehicle” state have each failed to exceed their respective “indeterminate” thresholds. In these instances, system 200 may be unable to determine the current state of the vehicle. For example, this may occur in situations with limited data availability (e.g., a desktop personal computer). After a predetermined period of time in this uncertain state, system 200 may transition to an “unknown” state.

Response component 230 is generally configured to determine actions in response to the state of the vehicle as determined by state analysis component 220 of system 200. Response component 230 may initiate a system action within a predefined time period. In an embodiment, the active operations may result in sending control signals to one or more subsystems of the vehicle. The action implemented by response component 230 may further provide notifications to the user as well as identified parties such as 911 or emergency contacts.

In an embodiment, system 200 may be configured to limit actions to certain types, such as only allowing notification operations, or allowing actions only for a limited set of states, in order to better control the responses to those that are appropriate for the circumstances or in accordance with the user's preferences.

As discussed above, vehicle state determinations have an associated uncertainty. Response component 230 may modify system actions by categorizing actions based on state scores and probabilities. For example, response component 230 may specify an action for states associated with higher state scores when there is also a higher likelihood that active operations will result in confirming the computing device is in a “remain” state.

As another example, response component 230 may specify an action for states associated with specified characteristics. By doing so, response component 230 may reserve a portion of the system action to states associated with locations that are more important for the user like the user's home or office. As another example, response component 230 may specify an action for states associated with lower state scores when there is a lower likelihood that active operations will result in confirming the computing device is in a remain state.

In an embodiment, response component 230 may implement a hierarchy among the potential actions based on state scores, user preferences, probabilities, or a combination thereof. Using this hierarchy, response component 230 may facilitate actions based on various confidence levels.

In an embodiment, response component 230 may be further configured to dynamically adjust actions using current vehicle and user state information. Examples of such current system state information include whether the user's computing device is in an off state, whether a display screen of the computing device is active or inactive (e.g., ON or OFF), characteristics of certain applications, etc.

Notification component 240 may be generally configured to provide one or more applications executing on the user's computing device with vehicle states related notifications. In an embodiment, notification component 240 may be implemented using an application programming interface. In cooperation with state analysis component 220, notification component 240 may provide other applications with notifications upon determining the vehicle has transitioned from one state to another. For example, notification component 240 may provide such notifications when the vehicle has entered a remain state, exited a remain state, or stays in a remain state. The notifications may include such information as the vehicle's: current position, current temperature, door status, number of occupants, and the like. In an embodiment, notification component 240 may issue notifications to applications upon determining that a state score exceeds a predetermined threshold (e.g., 0.7).

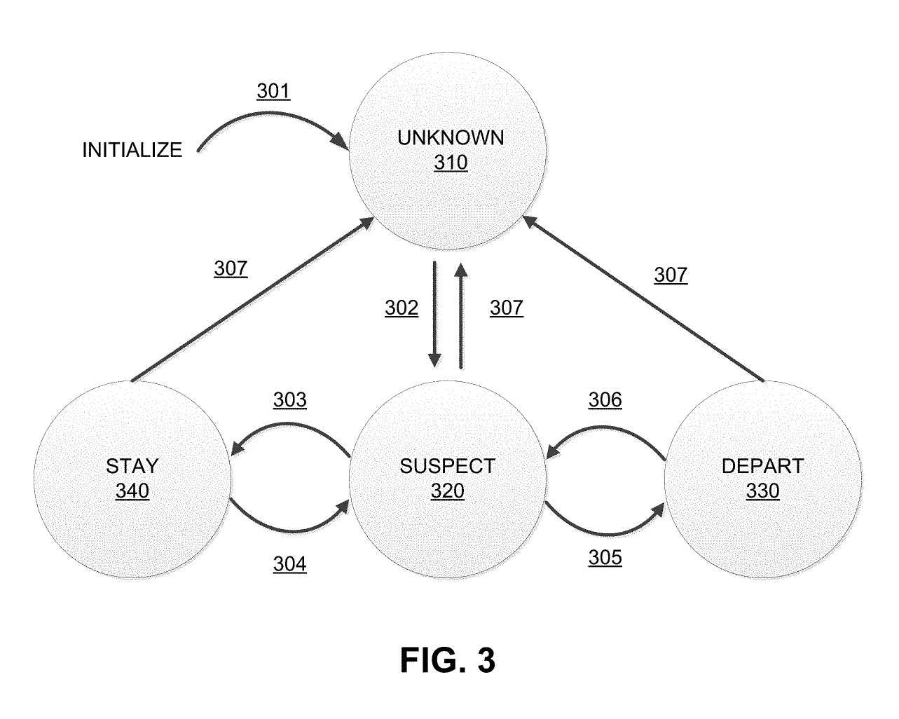

FIG. 3 shows a state diagram with four operation modes of an example vehicle state detection system 300 that may be implemented. The four operation modes are an unknown mode 310, a suspect mode 320, a stay mode 330, and a depart mode 340. While this example illustrates four operation modes, it should be understood that FIG. 3 only illustrates one example, and that many operation modes or states may be implemented.

In the four operation modes, system 300 may continue to monitor passive or active signals to determine the vehicle's current state. In one embodiment, in the unknown mode 310, system 300 may be mostly idle and does not cause any active operations. As indicated by transition 307, system 300 may switch to the unknown mode 310 from any other operation mode when it is unable to determine a current state of the vehicle from passive or active signals. System 300 may also operate in the unknown mode 310 when data is unavailable. One reason that data may be unavailable is system 300 lacks power, or is unable to access a network. When operating in the unknown mode 310, system 300 may periodically (e.g., “every few minutes” or when the passive or active signals start returning probability higher than “undetermined” for another state) switch to the suspect mode 320 to determine the current state, as shown by transition 302.

In suspect mode 320, system 300 may trigger operations to poll for the current state of the vehicle (e.g., by polling an on-board system, initiating Bluetooth scans, etc.). For example, if a location of the vehicle has not been obtained within a specified time, system 300 may poll for the current location while in suspect mode 320. In an embodiment, system 300 may trigger a subsequent active operation after a predefined time (e.g., 5 minutes) from a first polling operation to poll for data for the vehicle.

If data obtained in suspect mode 320 indicates that the vehicle is in a stay state, system 300 follows transition 303 to stay mode 330. Alternatively, if the data obtained in suspect mode 320 indicate the vehicle is in a depart state, system 300 follows transition 305 to depart mode 340. As discussed above, system 300 may also follow transition 307 to unknown mode 310 for at least the reasons discussed above.

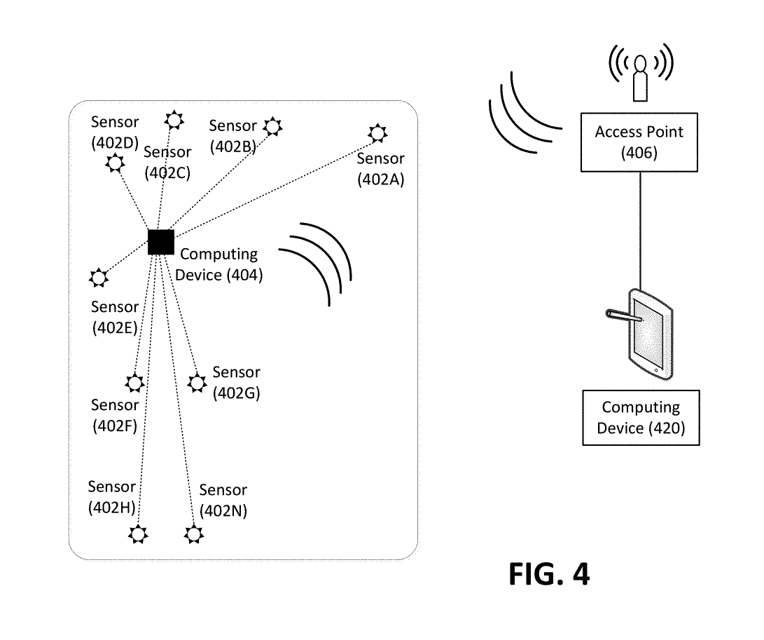

Turning to FIG. 4, an example of vehicle management system 400 is illustrated. The vehicle management system 400 is configured to collect data associated with a vehicle, analyze the collected data, perform one or more actions associated with the vehicle, and send notifications to the computing device 420. In an embodiment, the vehicle management system 400 may include or have access to a number of sensors 402A-N (which may be referred herein singularly as “sensor 402” or in the plural as “sensors 402”) connected to a computing device 404. The sensors 402 are configured to measure or otherwise obtain data indicative of various subsystems and components of the vehicle to the computing device 404, which in turn, processes and transmits information to and receives information from the computing device 420.

Each of the sensors 402 is typically attached to various locations in or on a vehicle. Although FIG. 2 shows nine sensors 402 located in various positions, this number can be larger or smaller depending on the size and purpose of the vehicle management system 400.

The computing device 404 of the vehicle management system 400 may interface with the computing device 420 by way of the access point 406, which may be any wireless access point utilizing technologies such as cellular and Wifi. However, in an example, an intermediary device can also be used. The computing device 420 may be a smartphone, a tablet, or another computing device that is capable of communicating directly with the computing device 404 via, for example, Bluetooth, or communicate with access point 406 to communicate with computing device 404.

Various data can be measured with regard to the vehicle's status. The sensor 402 can also be implemented as a virtual sensor that combines measurement and functionalities of the various types of sensors and devices. In other embodiments, the sensor 402 is an interface device can be a device that communicates with and obtains data from a sensor.

In one embodiment, the sensors 402 may be configured to transmit the measured data to the computing device 404, which may be configured to process the data. In some embodiments, the computing device 404 may not perform processing and may collect and transmit data to computing device 420, which may in turn execute functionality to process the received data.

In one embodiment, the computing device 404 may add time and location information to the processed data. The time may be measured by way of a clock operated by the computing device 404, while the location may be determined from the measured data or from a location sensor of the computing device 404 (e.g., circuitry that determines coordinates based on global positioning system (GPS), location triangulation techniques, etc.).

Moreover, the computing device 404 may correlate the data (e.g., the time and location stamped, labeled, and categorized data) with a particular detectable subject such as a person or animal. For example, the computing device 404 can receive information that identifies the current subject, or may be able to detect or infer the identity of the subject based on sensed data. Identity information can be provided by the computing device 420 or can be locally stored at the computing device 404. For example, the computing device 404 can add an identifier of the subject (e.g., name) to the data to allow the computing device 420 to identify the subject.

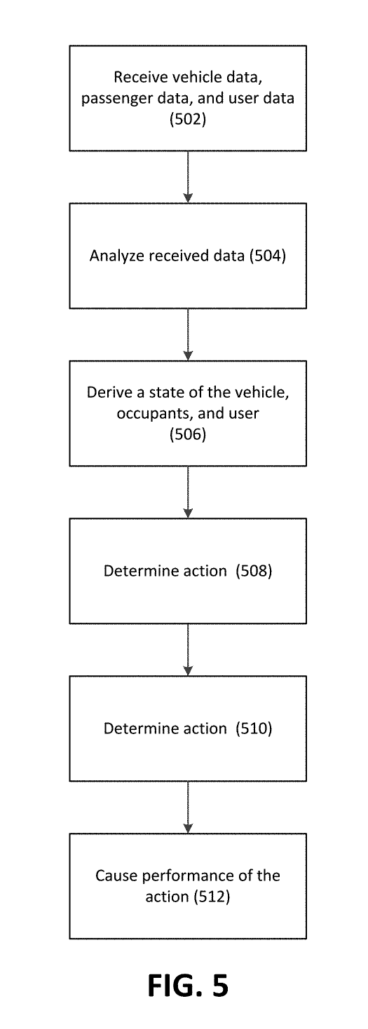

Turning to FIG. 5, an example operation for determining conditions associated with a vehicle is illustrated. Referring to FIG. 5, operation 502 illustrates receiving, by a computing system, vehicle data associated with one or more conditions of a vehicle, passenger data indicative of one or more occupants of the vehicle, and user data indicative of a state of a computing device associated with a user.

Operation 502 may be followed by operation 504. Operation 504 illustrates analyzing, by the computing system, the received environment data, passenger data, and user data.

Operation 504 may be followed by operation 506. Operation 506 illustrates based on the analyzing, deriving a state of the vehicle, occupants, and user.

Operation 506 may be followed by operation 508. Operation 508 illustrates in response to determining that the derived state is indicative of an unsafe condition, sending a notification to computing device associated with the user.

Operation 508 may be followed by operation 510. Operation 510 illustrates determining an action based at least in part on the derived state, the received vehicle data, passenger data, and user data, and one or more user preferences.

Operation 510 may be followed by operation 512. Operation 512 illustrates causing performance of the action via a communication to the vehicle, a communication to the computing device associated with the user, a communication to a predetermined contact, or a combination.

In some embodiments, the one or more conditions comprise an internal vehicle environment. In some embodiments, the one or more conditions comprise a status of one or more subsystems or components of the vehicle. In some embodiments, the passenger data comprises presence information for one or more occupants in the vehicle. In some embodiments, the passenger data comprises individual descriptive information for the one or more occupants in the vehicle. In some embodiments, the user data comprises a connection state of the computing device. In some embodiments, the user data comprises an operational of the computing device.

In some embodiments, the action comprises sending a notification to the computing device associated with the user, the notification indicative of the derived state. In some embodiments, the action comprises opening a window or roof of the vehicle. In some embodiments, the action comprises activating a climate control system of the vehicle.

In some embodiments, the action is performed without further input from the user. In some embodiments, the action is determined based on a rule-based inference function that receives as input the received environment data, passenger data, and user data.

In some embodiments, a notification is periodically sent to a computing device associated with the user, the notification providing a status of the determined state of the vehicle or the occupants

In some embodiments, the action is initiated when responses are not received from the computing device associated with the user within a timeout period, and the determined state is identified as a hazardous condition. In some embodiments, the action is initiated without further input when the determined state is identified as a hazardous condition.

In some embodiments, the inference function is updated based in a learning function. In some embodiments, the user settings are indicative of preferences for timing and severity of the action to be initiated.

The illustrations of the aspects described herein are intended to provide a general understanding of the structure of the various aspects. The illustrations are not intended to serve as a complete description of all of the elements and features of apparatus and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The techniques, or certain aspects or portions thereof, may, for example, take the form of program code (i.e., instructions) embodied in tangible storage media or memory media implemented as storage devices, such as magnetic or optical media, volatile or non-volatile media, such as RAM (e.g., SDRAM, DDR SDRAM, RDRAM, SRAM, etc.), ROM, etc., that may be included in computing devices or accessible by computing devices. When the program code is loaded into and executed by a machine, such as a computer, the machine becomes an apparatus for practicing the disclosure. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the disclosure, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

It should be understood that the various techniques described herein may be implemented in connection with hardware or software or, where appropriate, with a combination of both. The subject matter presented herein may be implemented as a computer process, a computer-controlled apparatus or a computing system or an article of manufacture, such as a computer-readable storage medium. The terms “circuitry”, “component”, or “module” are used interchangeably throughout and include hardware components such as hardware interrupt controllers, hard drives, network adaptors, graphics processors, hardware based video/audio codecs, and the firmware used to operate such hardware. The terms “circuitry”, “component”, or “module” can also include microprocessors, application specific integrated circuits, and processors, e.g., cores of a multi-core general processing unit that perform the reading and executing of instructions, configured by firmware and/or software. Processor(s) can be configured by instructions loaded from memory, e.g., RAM, ROM, firmware, and/or mass storage, embodying logic operable to configure the processor to perform a function(s).

In an example embodiment, where circuitry includes a combination of hardware and software, an implementer may write source code embodying logic that is subsequently compiled into machine readable code that can be executed by hardware. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

The previous description of the aspects is provided to enable a person skilled in the art to make or use the aspects. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed:

1. A method for determining conditions associated with a vehicle, the method comprising:
receiving, by a computing system, vehicle data associated with one or more conditions of a vehicle, passenger data indicative of one or more occupants of the vehicle, and user data indicative of a state of a computing device associated with a user;
analyzing, by the computing system, the received vehicle data, passenger data, and user data;
based on the analyzing, deriving a state of the vehicle, occupants, and user;
in response to determining that the derived state is indicative of an unsafe condition, sending a notification to computing device associated with the user;
determining an action based at least in part on the derived state, the received vehicle data, passenger data, and user data, one or more user preferences, and presence or absence of a communication from the computing device in response to the notification; and
causing performance of the action via a communication to the vehicle, a communication to the computing device associated with the user, a communication to a predetermined contact, or a combination thereof.

2. The method of claim 1, wherein the one or more conditions of the vehicle comprise an internal vehicle environment.

3. The method of claim 1, wherein the one or more conditions of the vehicle comprise a status of one or more subsystems or components of the vehicle.

4. The method of claim 1, wherein the passenger data comprises presence information for one or more occupants in the vehicle.

5. The method of claim 1, wherein the passenger data comprises individual descriptive information for the one or more occupants in the vehicle.

6. The method of claim 5, wherein the user data comprises a connection state of the computing device.

7. The method of claim 5, wherein the user data comprises an operational of the computing device.

8. The method of claim 5, wherein the action comprises sending a notification to the computing device associated with the user, the notification indicative of the derived state.

9. The method of claim 5, wherein the action comprises opening a window or roof of the vehicle.

10. The method of claim 5, wherein the action comprises activating a climate control system of the vehicle.

11. The method of claim 5, wherein the action is performed without further input from the user.

12. The method of claim 5, wherein the action is determined based on a rule-based inference function that receives as input the received environment data, passenger data, and user data.

13. A system comprising one or more processors that are configured to execute one or more executable instructions that cause the system to perform operations comprising:
receiving vehicle data indicative of conditions of a vehicle, passenger data indicative of occupants of the vehicle, and user data indicative of a state of a driver or controller of the vehicle;
invoking an inference function configured to receive the received vehicle data, passenger data, and user data as input and determine a state of the vehicle, occupants, and driver or controller; and
in response to determining that the state is indicative of an unsafe condition, initiating an action based at least in part on the determined state; the received vehicle data, passenger data, and user data; user settings; and whether instructions are received from the driver or controller.

14. The system of claim 13, wherein the one or more processors are configured to execute one or more executable instructions that cause the system to perform operations comprising causing performance of the action via a communication to the vehicle, a communication to a computing device associated with the user, a communication to a predetermined contact, or a combination thereof.

15. The system of claim 13, wherein the one or more processors are configured to execute one or more executable instructions that cause the system to perform operations comprising periodically sending a notification to a computing device associated with the user, the notification providing a status of the determined state of the vehicle or the occupants.

16. The system of claim 15, wherein the action is initiated when responses are not received from the computing device associated with the user within a timeout period, and the determined state is identified as a hazardous condition.

17. The system of claim 13, wherein the action is initiated without further input when the determined state is identified as a hazardous condition.

18. The system of claim 13, wherein the inference function is updated based in a learning function.

19. The system of claim 13, wherein the user settings are indicative of preferences for timing and severity of the action to be initiated.

20. A computing device comprising at least one memory having stored therein computer instructions that, upon execution by one or more processors of the computing device, at least cause the computing device to:
receive data indicative of conditions of a vehicle, occupants of the vehicle, and a state of a user of the vehicle;
based on the received data, determine a state of the vehicle, occupants, and user; and
in response to determining that the state is indicative of an unsafe condition and that communication with the user is unavailable, automatically initiating an action determined based at least in part on the determined state and the received data.
